(19) United States
(12) Patent Application Publication
(10) Pub. No.: US 2025/0005366 A1
(43) Pub. Date: Jan. 2, 2025

(54) SYSTEM AND METHOD FOR GENERATING A SOLUTION USING MACHINE LEARNING

(71) Applicant: Progress, Inc., West Bloomfield, MI (US)

(72) Inventors: Ivan Negreshnyi, SR., Lugansk (UA); Ivan Negreshnyi, JR., Lugansk (UA); Vladimir Proseanic, West Bloomfield, MI (US); James Cook, Dearborn, MI (US); Anatol Guin, Astana (KZ); Oleg Gafurov, Moscow (RU); Vladimir Matsenko, Lugansk (UA)

(73) Assignee: Progress, Inc., West Bloomfield, MI (US)

(21) Appl. No.: 18/761,125

(22) Filed: Jul. 1, 2024

Related U.S. Application Data
(60) Provisional application No. 63/524,654, filed on Jul. 1, 2023.

(51) Int. Cl. G06N 3/084

(52) U.S. Cl. CPC G06N 3/084

(57) ABSTRACT

A method of machine learning includes receiving a request for a solution and defining a set of input values correlated to the received request. The method also includes extracting, via an electronic controller, data values from a data repository in response and correlated to the defined set of input values. The method further includes generating, via the electronic controller, the solution using the received request and the extracted data values. A system for machine learning includes a data repository configured to store data values and an electronic controller configured to manage a request for a solution according to the method.

### CROSS-REFERENCE TO RELATED APPLICATION(S)

This application claims the benefit of U.S. Provisional Application Ser. No. 63/524,654 filed Jul. 1, 2023, the entire content of which is hereby incorporated by reference.

### INTRODUCTION

The disclosure relates to a system for machine learning and a method for generating a solution using the same.

Broadly, artificial intelligence is a theory and development of computer systems able to perform tasks that normally require human intelligence, such as visual perception, speech recognition, decision-making, and translation between languages. Artificial intelligence may employ machine learning to achieve a prescribed result. Machine learning is the use and development of computer systems capable of learning and adapting without following explicit instructions. Machine learning generally aims to use algorithms and statistical models to teach a machine to perform a specific task and provide accurate results by identifying, analyzing, and drawing inferences from patterns in data. While artificial intelligence typically encompasses the idea of a machine that can mimic human intelligence, machine learning on its own is not specifically devised to do so.

In machine learning, the term “artificial neural network” generally refers to software and/or computer architecture, i.e., the overall design or structure of a computer system or a microprocessor, including the hardware and software required to run it. Such artificial neural networks can be a family of statistical learning algorithms inspired by biological neural networks, a.k.a., the central nervous systems of animals, in particular the brain. Artificial neural networks are primarily used to estimate or approximate generally unknown functions that can depend on a large number of inputs. Such neural networks have been used for a wide variety of tasks that are difficult to resolve using ordinary rule-based programming, including computer vision (digital images) and speech recognition. Artificial neural networks are generally structured as systems of connections or “neurons” configured to compute values based on input factors, and, because of their adaptive nature, capable of machine learning, as well as pattern recognition.

### SUMMARY

A method of machine learning includes receiving a request for a solution and defining a set of input values correlated to the received request. The method also includes extracting, via an electronic controller, data values from a data repository, e.g., a database or dataset (and in some cases the i-net), in response and correlated to the defined set of input values. The method further includes generating, via the electronic controller, the solution using the received request and the extracted data values.

The method may also include determining one or more coefficients using the extracted data values and assigning one or more of the determined coefficients to each of the extracted data values.

The method may additionally include, concurrently with determining the coefficient(s), via the electronic controller, receiving a modified request for the solution based on divergence of the generated solution from an expected solution; defining an updated set of input values correlated to the modified request; extracting, updated data values from the data repository in response and correlated to the updated set of input values; and generating the solution using the modified request and the extracted updated data values.

The method may additionally include assessing data values within the data repository based on divergence of the generated solution from an expected solution and adjusting the determined coefficients via determining a root mean square or an average value of the subject coefficients.

The method may also include adjusting, via the electronic controller, the coefficient(s) following the generating of the solution in a feedback loop based on divergence of the generated solution from an expected solution to enhance the solution.

The method may also include determining a deviation of the extracted data values from the respective input values, and adjusting the determined coefficients may be used to reduce the deviation of the data values from the set of input values.

The method may additionally include assessing data values within the data repository based on divergence of the generated solution from an expected solution and adjusting the data values directly in the data repository when the divergence exceeds a predetermined margin.

The method may also include assessing data values within the data repository based on divergence of the generated solution from an expected solution. In such as embodiment, the method may also include determining which data values within the data repository are responsible for the divergence that exceeds a predetermined margin via including individual input values of the defined set with the generated solution.

Generating the solution, using the received input and the extracted data values, may include structuring an artificial neural network, via the electronic controller using a computer implemented algorithm, the received request for a solution, and the extracted data values. In such an embodiment, the method may also include training the artificial neural network, via the electronic controller, using the extracted data values, and entering, via the electronic controller, the request for the solution into the trained artificial neural network to generate the solution.

An operative structure of the artificial neural network may include a plurality of inputs and at least one neuron. Each neuron may be connected to at least one of the inputs via a respective synapse having a plurality of selectable corrective weights associated therewith. In such an embodiment, training of the neural network may include selecting, in correlation with the set of input values, one or more corrective weights on each synapse; aggregating, via each neuron, corrective weights selected on corresponding synapses to generate a respective neuron sum; determining a deviation of each neuron sum from a corresponding input value in the defined set of input values; and modifying the respective corrective weights to minimize the determined deviation.

A system for machine learning including a data repository configured to store data values and an electronic controller configured (constructed and programmed) to manage a request for a solution according to the method is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic illustration of a system for machine learning including a data repository and an electronic controller for managing a request for a corresponding solution, according to the disclosure.

FIG. 2 is a schematic illustration of a classical artificial neural network.

FIG. 3 is a schematic illustration of a “progressive neural network” (p-net) having a plurality of synapses, a set of distributors, and a plurality of corrective weights associated with each synapse.

FIG. 4 is a flow diagram of a method used for machine learning according to the present disclosure, using the structures shown in FIGS. 1-3.

### DETAILED DESCRIPTION

Embodiments of the present disclosure as described herein are intended to serve as examples. Other embodiments can take various and alternative forms. Additionally, the drawings are generally schematic and not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure. Moreover, the teachings may be described herein in terms of functional and/or logical block components and/or various processing steps. It should be realized that such block components may include a number of hardware, software, and/or firmware components configured to perform the specified functions.

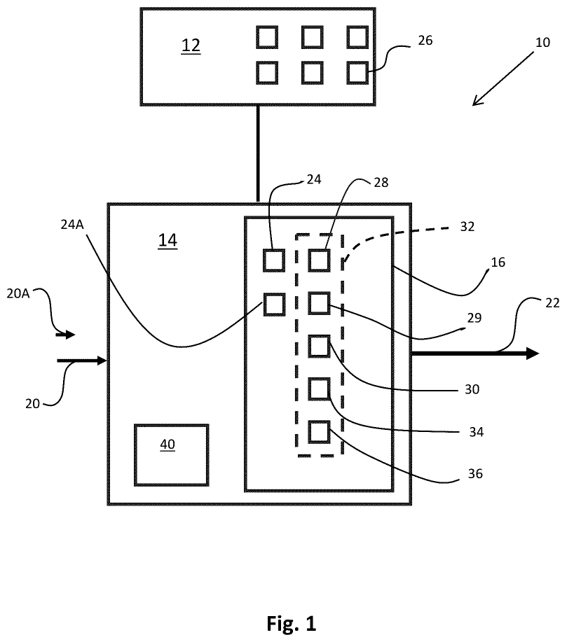

Referring to the drawings, wherein like reference numbers refer to like components, FIG. 1 shows a schematic view of system 10 specifically configured to execute machine learning. The system 10 includes a data repository 12, which may be a dataset or a database, and in some cases the i-net, configured to store data values to be used for machine learning. The system 10 also includes an electronic controller or computer 14. As shown, electronic controller 14 is configured to regulate machine learning within the context of system 10, and as such is a means for executing the actions described in detail below. To appropriately perform the tasks described in detail below, the controller 14 specifically includes a processor, transitory memory, as well as tangible, non-transitory memory, which includes requisite instructions programmed therein.

The memory of controller 14 may be a recordable medium that participates in providing computer-readable data or process instructions. Such a medium may take many forms, including but not limited to non-volatile media and volatile media. Non-volatile media for the controller 14 may include, for example, optical or magnetic disks and other persistent memory. Volatile media may include, for example, dynamic random access memory (DRAM), which may constitute a main memory. Such instructions may be transmitted by one or more transmission medium, including coaxial cables, copper wire and fiber optics, including the wires that comprise a system bus coupled to a processor of a computer. Memory of the controller 14 may also include an appropriate means, for example a magnetic or an optical medium.

The controller 14 may be configured or equipped with other required computer hardware, such as a high-speed clock, requisite Analog-to-Digital (A/D) and/or Digital-to-Analog (D/A) circuitry, necessary input/output circuitry and devices (I/O), as well as appropriate signal conditioning and/or buffer circuitry. The controller 14 also includes algorithm(s), indicated generally via numeral 16, generally structured as a formula coded into software and accessible by the controller to instruct the controller's processor to solve a specific problem. Algorithm(s) 16 may be stored in the controller's memory and automatically executed to provide the required functionality of the system 10 described in detail below.

Specifically, the controller 14 is configured, i.e., structured and programmed, to receive a request 20 for a solution 22, i.e., a result providing, for example, identification/recognition of a pattern and/or predictive output using machine learning. The electronic controller 14 is configured to use algorithm(s) 16 to define a set 24 of input values correlated to, e.g., analytically or empirically associated with, the received request 20. The electronic controller 14 is also configured to extract data values from the data repository 12 in response and correlated to the defined set 24 of input values, thereby specifying or defining extracted data values 26. The electronic controller 14 is additionally configured to generate the requested solution 22 using the received request 20 and the extracted data values 26. The electronic controller 14 may also be configured to sort and filter the incoming data, i.e., the data values within and/or extracted from the data repository 12.

The electronic controller 14 may also apportion the significance of individual extracted data values 26 in generating the requested solution 22. For example, electronic controller 14 may be configured to determine one or more coefficients 28 using the extracted data values 26 and assign one or more of the determined coefficients to each of the extracted data values. In other words, the electronic controller 14 may assign at least one of the determined coefficients 28 to each one of the extracted data values to generate respective weighted or updated (extracted) data values 26A. The electronic controller 14 may also be configured to receive a modified request 20A for the solution 22 while the machine learning is in process based on divergence 29 of the generated solution 22 from an expected solution 30. The expected solution 30 may be established during training of particular machine structures using an appropriate computer implemented algorithm 16. Such machine structures may include various models such as decision trees, support-vector machines, and incorporate various practices and analyses, e.g., Bayesian networks, Gaussian processes, Genetic algorithms, etc. A particular algorithm 16 may be implemented to structure an artificial neural network discussed in detail below.

The electronic controller 14 may be further configured to define an updated set 24A of input values correlated to the modified request 20A and extract updated data values 26A from the data repository 12 in response and correlated to the updated input values. Additionally, the electronic controller 14 may be configured to generate the requested solution 22 using the modified request 20A and the extracted updated data values 26A. Each of the receiving the modified request 20A, defining the updated set 24A of input values, and extracting the updated data values 26A may be performed by the electronic controller 14 concurrently with the determination of the coefficient(s) 28.

The electronic controller 14 may be additionally configured to adjust the coefficient(s) 28 following initial generation of the solution 22 while the machine learning is in process to enhance the requested solution. Such adjustment of the coefficient(s) 28 may be accomplished in a feedback loop 32 based on divergence 29 of the generated solution 22 from the expected solution 30 thereby converging on the requested solution 22. For example, the electronic controller 14 may be configured to determine a deviation 34 of the extracted data values 26 from the set 24 of input values and adjust the determined coefficient(s) 28 to reduce the subject. The adjustment of the determined coefficient(s) 28 may be carried out to minimize the deviation 34 to a preset, acceptable magnitude. The electronic controller 14 may be also configured to adjust or correct the extracted data values 26 directly in the data repository 12 when the divergence 29 of the generated solution 22 from the expected solution 30 exceeds a predetermined margin 36.

The electronic controller 14 may also be configured to assess data values stored within the data repository 12 based on divergence 29 of the generated solution 22 from the expected solution 30. In such an embodiment, the electronic controller 14 may determine or identify which data values within the data repository 12 are responsible for the divergence 29 that exceeds the predetermined margin 36. Identification of the data values responsible for excessive divergence may be accomplished by including individual input values of the defined set 24 with the generated solution 22, allowing the correlation between the input values and the solution to be tracked. Such identification of specific stored data values as the cause of the respective divergence 29 may be useful for reference and/or accounting purposes, e.g., for future inquiries accessing the data repository 12.

The electronic controller 14 may be additionally configured to adjust the determined coefficients 28 via determining either a root mean square or an average value of the subject coefficients. Furthermore, the resultant value may then be substituted for the original coefficients and thus adjusted coefficients assigned to the corresponding extracted data values 26. Such adjustment of the coefficients 28 may be, for example, accomplished in response to the identified divergence 29 of the generated solution 22 from the expected solution 30.

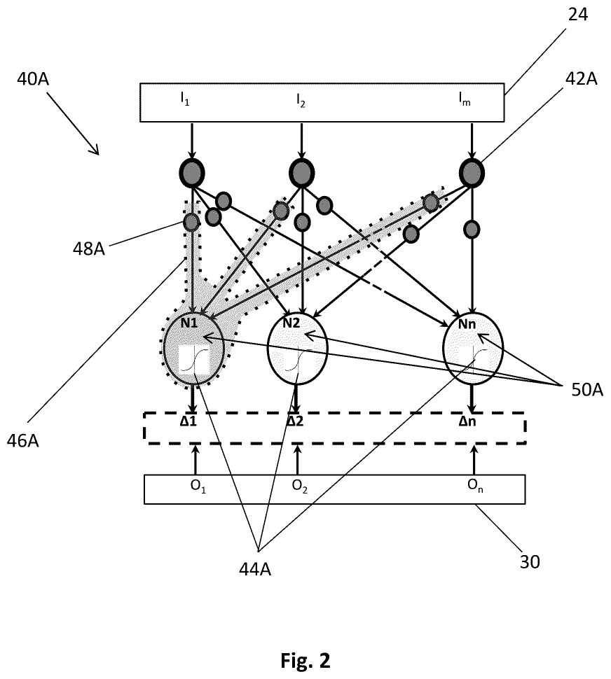

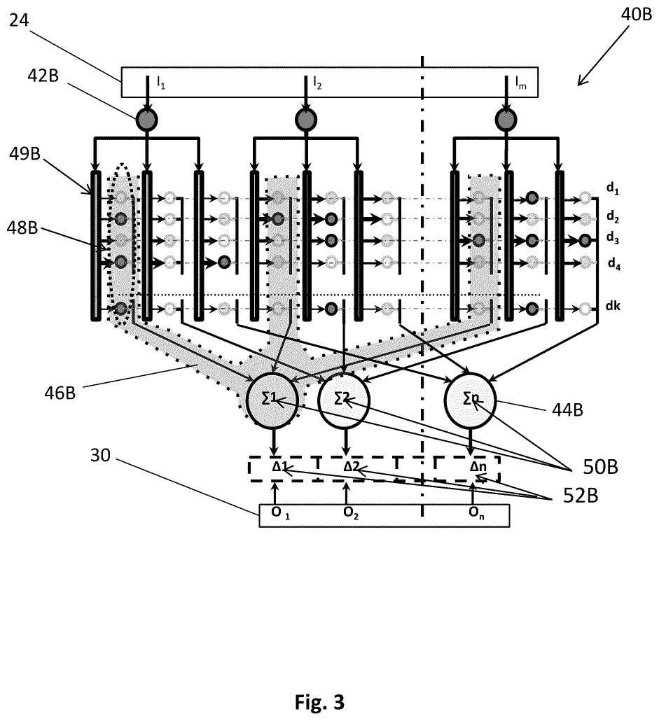

As noted above, the electronic controller 14 may be programmed to generate the solution 22 by structuring and operating an artificial neural network 40 (shown generally in FIG. 1). The electronic controller 14 may employ a particular computer implemented algorithm 16, received input via the request 20 for the solution, and the extracted data values 26. Specifically, the electronic controller 14 may train the structured artificial neural network 40 using the extracted data values 26 and entering the request 20 into the trained artificial neural network to generate the solution 22. The artificial neural network 40 may be a classical neural network 40A having a structure depicted in FIG. 2 or a “progressive neural network” (p-net) 40B shown in FIG. 3.

As shown in FIG. 2, the operative classical structure 40A of the artificial neural network 40 includes a plurality of inputs or network input devices 42A for receiving the set 24 of input values. The inputs 42A of the classical neural network 40A also include individual neurons 44A, including an adder and activation function device, configured to generate respective neuron outputs. Each neuron 44A is connected via individual synapses 46A to multiple inputs 42A. Furthermore, each of the synapses 46A of the classical neural network 40A includes a particular synaptic weight 48A. The neuron 44A outputs are in turn combined to generate a respective neuron sum 50A. The electronic controller 14 may be programmed to train the classical neural network 40A by receiving the set 24 of input values via the inputs 42A and, during machine learning, output the requested solution 22.

Analogously, as shown in FIG. 3, the operative p-net structure 40B of the artificial neural network 40 includes a plurality of inputs 42B and at least one neuron 44B. As shown, each neuron 44B is connected to at least one of the inputs 42B via a respective synapse 46B having, distinctively from the classical neural network 40A, a plurality of selectable corrective weights 48B associated therewith. The electronic controller 14 may be programmed to train the subject neural network 40B by initially receiving the set 24 of input values via the inputs 42B. The electronic controller 14 may be programmed to further train the subject p-net neural network 40 by selecting, in correlation with the extracted data values 26, one or more corrective weights 48B on each synapse 46B.

The corrective weights 48B of p-net 40B may be selected by a distributor 49B associated with each individual synapse 46B. The electronic controller 14 may continue to train the subject neural network 40B by aggregating, via each neuron 44B, corrective weights 48B selected on corresponding synapses 46B to generate a respective neuron sum 50B. The electronic controller 14 may further determine a deviation 52B of each neuron sum 50B from a corresponding input value in the defined set 24 and modify the respective corrective weights 48B to minimize the determined deviation 52B. The trained neural network 40 may be stored in a non-transitory computer-readable storage device enabling the electronic controller 14 to access and operate the artificial neural network or be maintained temporarily for a respective machine learning cycle in volatile memory of the electronic controller or a corresponding processor.

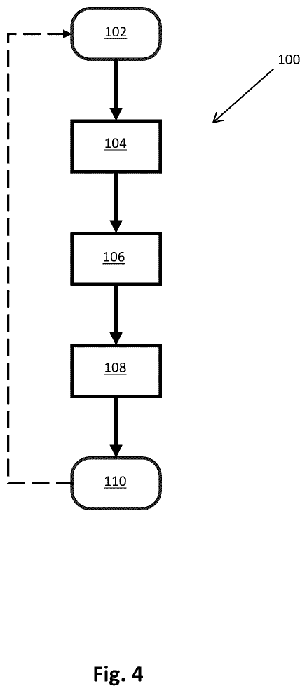

FIG. 4 depicts a method 100 of machine learning using a system 10, as described above with respect to FIGS. 1-3. The method 100 commences in frame 102 where the method includes receiving the request 20 for solution 22, such as an identification/recognition of a pattern and/or a predictive output. Following frame 102, the method advances to frame 104. In frame 104, the method includes defining the set 24 of input values correlated to the received request 20. After frame 104, the method proceeds to frame 106, in which the method includes extracting, via the electronic controller 14, data values from the data repository 12 in response and correlated to the defined set 24 of input values. Following frame 106, the method advances to frame 108. In frame 108, the method includes generating, via the electronic controller 14, the solution 22 using the received request 20 and the extracted data values 26.

In frame 108, in one embodiment, the method may additionally include determining, via the electronic controller 14, coefficient(s) 28 using the extracted data values 26 and assigning one or more of the determined coefficients to each of the extracted data values. Concurrently with determining the coefficient(s) 28, in frame 108 the method may include receiving the modified request 20A for the solution based on the divergence 29 of the generated solution 22 from the expected solution 30. Additionally, in frame 108 the method may include defining updated set 24A of input values correlated to the modified request 20A and extracting updated data values 26A from the data repository 12 in response and correlated to the updated set 24A of input values. In frame 108, the method may further include generating solution 22 using the modified request 20A and the extracted updated data values 26A.

In another embodiment, in frame 108, the method may additionally include adjusting, via the electronic controller 14, the coefficient(s) 28 following the generation of the solution using the feedback loop 32 based on divergence 29 of the generated solution 22 from an expected solution 30 to enhance the solution. The method may further include determining the deviation 34 of the extracted data values 26 from the set 24 of input values, such that adjusting the determined coefficient(s) 28 is configured to reduce the subject deviation. Alternatively, in frame 108, the method may include assessing data values within the data repository 12 based on the divergence 29 and adjusting the data values directly in the data repository when the divergence exceeds the predetermined margin 36.

In another embodiment, in frame 108, the method may include assessing data values within the data repository 12 based on divergence 29 to determine which data repository values are responsible for the divergence 29 that exceeds the predetermined margin 36. As described above with respect to FIG. 1, such a determination may be affected by including individual input values of the defined set 24 with the generated solution 22 to track the correlation between the two. In another embodiment, in frame 108, the method may include adjusting the determined coefficients 28 via determining a root mean square or an average value of the subject coefficients and assigning the resultant value to the effective coefficients.

As described with respect to FIG. 1, generating the solution 22 in frame 108 may include structuring the artificial neural network 40, via the electronic controller 14 using the respective computer implemented algorithm 16, the received request 20, and the extracted data values 26. In such an embodiment, generating the solution may additionally include training the artificial neural network using the extracted data values 26 and entering the request 20 into the trained artificial neural network to generate the solution 22. As described in detail above, the artificial neural network 40 may be a classical neural network 40A having the structure depicted in FIG. 2 or a “progressive neural network” (p-net) 40B shown in FIG. 3.

Following frame 108, method 100 may conclude in frame 110 or return to frame 102 for receiving another request to generate a solution. Overall, the method 100 of machine learning permits concurrently or consecutively defining and modifying a set of input values correlated to a received request, extracting data values from a data repository in response and correlated to the defined set of input values, and generating a requested solution using the received request and the extracted data values.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A method of machine learning, the method comprising:
receiving a request for a solution;
defining a set of input values correlated to the received request;
extracting, via an electronic controller, data values from a data repository in response and correlated to the defined set of input values; and
generating, via the electronic controller, the solution using the received request and the extracted data values.

2. The method according to claim 1, further comprising:
determining one or more coefficients using the extracted data values; and
assigning one or more of the determined coefficients to each of the extracted data values.

3. The method according to claim 2, further comprising, concurrently with determining the one or more coefficients, via the electronic controller:
receiving a modified request for the solution based on divergence of the generated solution from an expected solution;
defining an updated set of input values correlated to the modified request;
extracting updated data values from the data repository in response and correlated to the updated set of input values; and
generating the solution using the modified request and the extracted updated data values.

4. The method according to claim 2, further comprising:
assessing data values within the data repository based on divergence of the generated solution from an expected solution; and
adjusting the determined coefficients via determining one of a root mean square and an average value of the subject coefficients.

5. The method according to claim 2, further comprising adjusting, via the electronic controller, the one or more coefficients following the generating of the solution in a feedback loop based on divergence of the generated solution from an expected solution to enhance the solution.

6. The method according to claim 5, further comprising determining a deviation of the extracted data values from the set of input values, and wherein adjusting the determined coefficients is configured to reduce the deviation of the extracted data values from the set of input values.

7. The method according to claim 1, further comprising:
assessing data values within the data repository based on divergence of the generated solution from an expected solution; and
adjusting the data values directly in the data repository when the divergence exceeds a predetermined margin.

8. The method according to claim 1, further comprising:
assessing data values within the data repository based on divergence of the generated solution from an expected solution; and
determining which data values within the data repository are responsible for the divergence that exceeds a predetermined margin via including individual input values with the generated solution.

9. The method according to claim 1, wherein generating the solution includes:
structuring an artificial neural network, via the electronic controller using a computer implemented algorithm, the received request for a solution, and the extracted data values;
training the artificial neural network, via the electronic controller, using the extracted data values; and
entering, via the electronic controller, the request for the solution into the trained artificial neural network to generate the solution.

10. The method according to claim 9, wherein an operative structure of the neural network includes a plurality of inputs and at least one neuron, wherein each neuron is connected to at least one of the inputs via a respective synapse having a plurality of selectable corrective weights associated therewith, and wherein training of the neural network includes:
selecting, in correlation with the set of input values, one or more corrective weights on each synapse;
aggregating, via each neuron, corrective weights selected on corresponding synapses to generate a respective neuron sum;
determining a deviation of each neuron sum from a corresponding input value in the defined set of input values; and
modifying the respective corrective weights to minimize the determined deviation.

11. A system for machine learning, the system comprising:
a data repository configured to store data values; and
an electronic controller configured to:
receive a request for a solution;
define a set of input values correlated to the received request;
extract data values from the data repository in response and correlated to the defined set of input values; and
generate the solution using the received request and the extracted data values.

12. The system according to claim 11, wherein the electronic controller is additionally configured to:
determine one or more coefficients using the extracted data values; and
assign one or more of the determined coefficients to each of the extracted data values.

13. The system according to claim 12, wherein the electronic controller is additionally configured to, concurrently with the determination of the one or more coefficients:
receive a modified request for the solution based on divergence of the generated solution from an expected solution;
define an updated set of input values correlated to the modified request;
extract updated data values from the data repository in response and correlated to the updated set of input values; and
generate the solution using the modified request and the extracted updated data values.

14. The system according to claim 12, wherein the electronic controller is additionally configured to:
assess data values within the data repository based on divergence of the generated solution from an expected solution; and
adjust the determined coefficients via determining one of a root mean square and an average value of the subject coefficients.

15. The system according to claim 12, wherein the electronic controller is additionally configured to adjust the one or more coefficients following the generation of the solution in a feedback loop based on divergence of the generated solution from an expected solution to enhance the solution.

16. The system according to claim 15, wherein the electronic controller is additionally configured to determine a deviation of the extracted data values from the set of input values and adjust the determined coefficients to reduce the deviation of the extracted data values from the set of input values.

17. The system according to claim 11, wherein the electronic controller is additionally configured to:
assess data values within the data repository based on divergence of the generated solution from an expected solution; and
adjust the data values directly in the data repository when the divergence exceeds a predetermined margin.

18. The system according to claim 11, wherein the electronic controller is additionally configured to:
assess data values within the data repository based on divergence of the generated solution from an expected solution; and
determine which data values within the data repository are responsible for the divergence that exceeds a predetermined margin via including individual input values with the generated solution.

19. The system according to claim 11, wherein the electronic controller is configured to generate the solution by:
structuring an artificial neural network, using a computer implemented algorithm, the received request for a solution, and the extracted data values;
training the artificial neural network using the extracted data values; and
entering the request for the solution into the trained artificial neural network to generate the solution.

20. The system according to claim 19, wherein an operative structure of the artificial neural network includes a plurality of inputs and at least one neuron, wherein each neuron is connected to at least one of the inputs via a respective synapse having a plurality of selectable corrective weights associated therewith, and wherein the electronic controller is configured to train the neural network by:
selecting, in correlation with the set of input values, one or more corrective weights on each synapse;
aggregating, via each neuron, corrective weights selected on corresponding synapses to generate a respective neuron sum;
determining a deviation of each neuron sum from a corresponding input value in the defined set of input values; and
modifying the respective corrective weights to minimize the determined deviation.
